(19) United States
(12) Patent Application Publication
(10) Pub. No.: US 2006/0179758 A1
(43) Pub. Date: Aug. 17, 2006

(54) Protective structure for an apparatus for the handling of containers

(76) Inventors: Andrea Zuccheri, Parma (IT); Massimo Gorbi, Parma (IT); Paolo Madoi, Parma (IT)

Correspondence Address: DICKSTEIN SHAPIRO MORIN & OSHINSKY LLP, 2101 L Street, NW, Washington, DC, 20037, US

(21) Appl. No.: 10/560,248

(22) PCT Filed: Jun. 26, 2003
(86) PCT No.: PCT/IT03/00397

§ 371 Date: Mar. 22, 2006

(51) Int. Cl. E06B 3/54

(52) U.S. Cl. 52/474

(57) ABSTRACT

The invention relates to a protective structure for machines or apparatus, in particular an apparatus for the handling of containers, which has a barrier to limit noise emissions to the external environment. In particular, the invention relates to a protective structure 1 for an apparatus for the handling of containers comprising a frame 2, panels 9 for insulating it from the external environment, fastened to said frame 2 by fastening means 10 which create a gap between said frame 2 and said panels 9, and gasket means arranged in said gap, characterized in that said gasket means comprise gasket walls 11 which can be expanded by blowing in fluids under pressure.

The invention relates to a protective structure for machines or apparatus, in particular apparatus for the handling of containers, which has a barrier to limit noise emissions to the external environment.

The apparatus for the handling of containers to which the invention refers, such as for example apparatus for the handling of bottles, are completely automated apparatus consisting of various stations for processing the containers, such as for example blowing, rinsing, filling, capping, labelling and packaging machines, connected to each other by means of conveyor belts which transfer the containers from one station to another. Each work station is enclosed in a protective structure which forms boundaries separating an internal environment in which the handling equipment is arranged from the external environment. In this way, it is possible to create in the internal environment particular conditions which may be necessary for particular types of processing applied to the containers. For example, inside each individual processing station it is possible to create particular conditions of pressure, humidity and temperature, or to create an aseptic area by blowing sterile air into the internal environment. Moreover, said protective structures also act as real barriers protecting the operator, who is located outside, from the internal environment.

In the closed areas of the protective provisions or casings of the machines, gaskets are also fitted for the purpose of limiting noise emissions from the equipment. Conventional gaskets are fixed. They are normally fitted at the joint of the protective panel by mechanical fastening or bonding to the sealing surface.

The fitting of gaskets in this way is certainly valid as a barrier to noise emission, since it effectively insulates the internal environment from the external one, but has the major disadvantage of not being completely washable. This is because in the fastening areas themselves, between the gasket and the panel or between the gasket and the upright of the frame, gaps are formed which are difficult to reach and which may allow dirt to enter and accumulate. For example in the case of bottle handling machines, and in particular filling machines, liquid residues may collect in the gaps, or in the case of labelling machines adhesive residues, which seep or drain from the equipment of the processing station in operation. This contamination, which involves an increase in gasket cleaning operations, may also be the cause of a loss of serviceability of these gaskets.

The problem addressed by the invention is therefore that of providing a device capable of creating a barrier to limit the noise emission of a machine or apparatus to the external environment and at the same time ensure maximum cleanability of the barrier itself and of the gasket.

This problem is solved by a protective structure for equipment for the handling of containers as outlined in the appended claims.

Other characteristics and advantages of the protective structure for equipment for the handling of containers which is the subject of the invention will become clear from the description of an example of embodiment given below purely by way of non-limiting example, with reference to the following drawings:

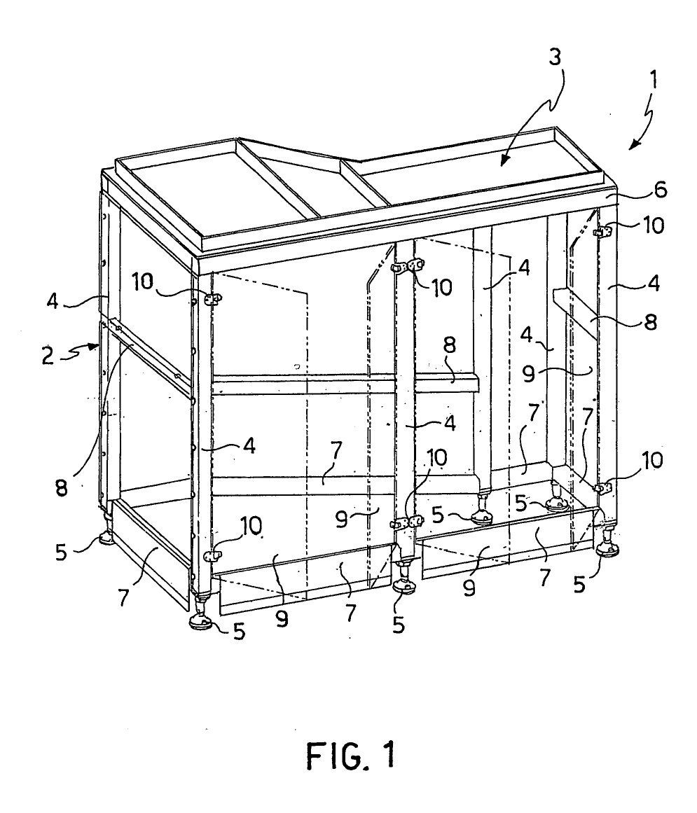

FIG. 1 shows a perspective view of a protective structure for an apparatus for the handling of containers according to the invention;

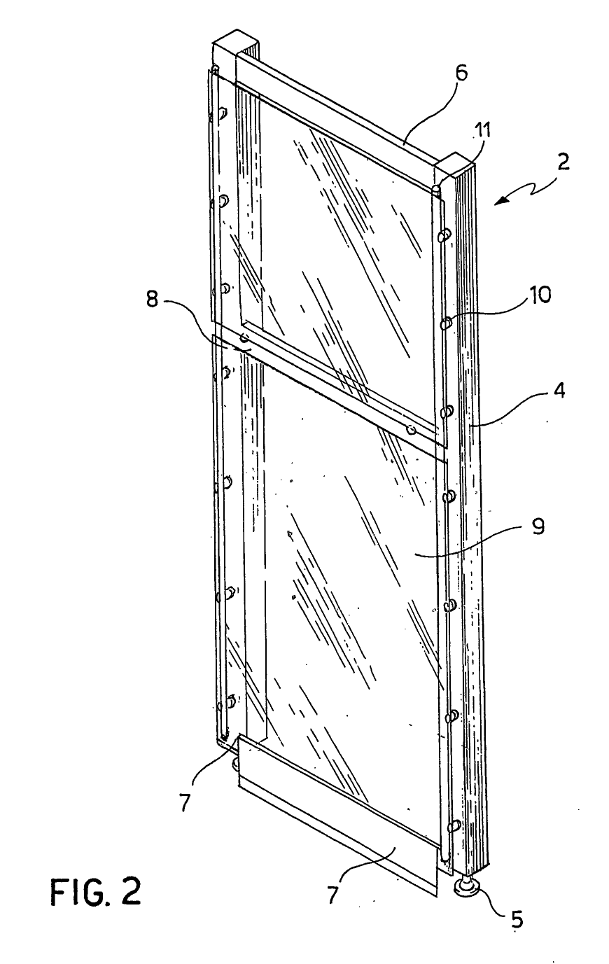

FIG. 2 shows a perspective view, from the external environment, of a fixed protective panel which is a detail of the structure in FIG. 1;

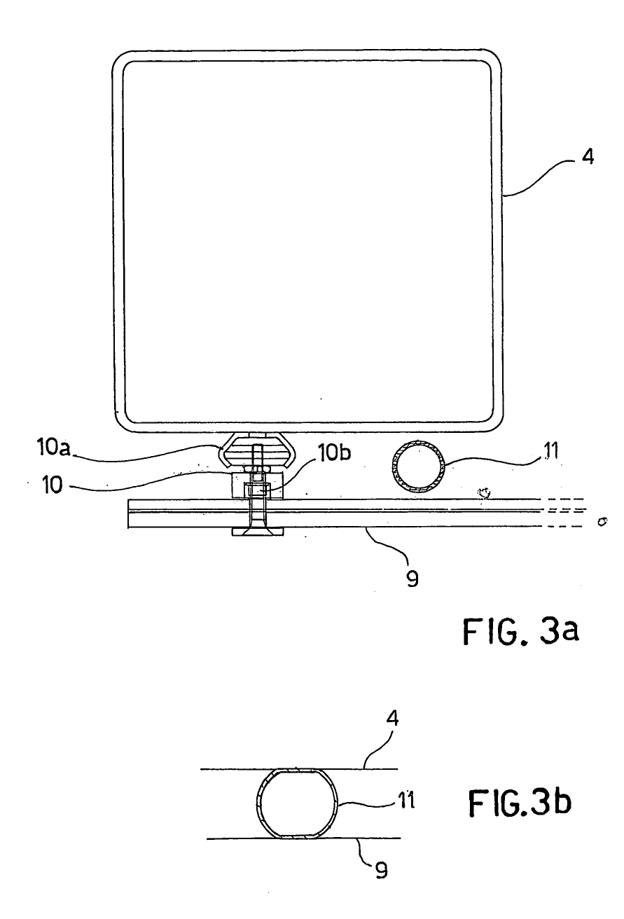

FIG. 3a shows a cross-sectional view from above of a detail of a protective panel according to a particular form of embodiment of the invention;

FIG. 3b shows a cross-section view of the expanded gasket wall, a detail of FIG. 3a;

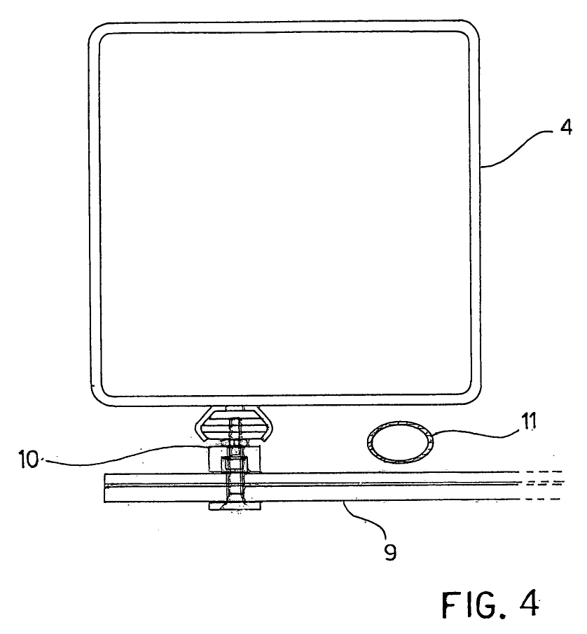

FIG. 4 shows the view in FIG. 3a according to a further form of embodiment.

With reference to FIG. 1, the protective structure for an apparatus for the handling of containers, indicated as a whole by the number 1, comprises a fixed part consisting of a frame 2 supporting a plate 3, which on the one hand has the function of closing the shielding structure from above and on the other may optionally support operating units (not shown) of the handling apparatus, such as for example in the equipment described in patent application EP 1 295 818. The frame 2 also comprises a plurality of uprights 4, fitted with feet 5, connected at the upper ends by a perimeter edge 6 and by reinforcing bars 7, 8.

The side spaces of the frame 2 comprised between the uprights 4, the upper perimeter edge 6 and said reinforcing bars 7 may be closed by panels 9. These panels are preferably transparent so as to allow visual inspection of the operation of the equipment inside the apparatus. These panels 9 may be connected, on one or more sides, to the uprights 4 by fastening means 10.

Along the entire length of the reinforcing bars 7, at the lower edge of the panels 9 are fitted skirt gaskets 12, preferably of rubber, which extend down to the ground to close the space bounded by the bar 7 and the two feet 5.

The panels 9 are connected to the uprights 4 in a fixed or movable manner. In the latter manner, the panels may be openable to give access to the inside of the processing area of the apparatus. In the form of embodiment in which the panels 9 are movable, the above-mentioned fastening means 10 between the panel 9 and the upright 4 of the frame preferably contain guiding means which allow the movable panels to be opened by sliding them upwards (as shown in FIGS. 3a and 4), or hingeing means or locking means in the case of movable panels of the window type (as shown in FIG. 1).

FIGS. 3a and 4 show a preferred form of embodiment of a movable panel according to the invention, with fastening means 10 comprising guiding means 10a fastened to the upright 4, which run along its entire length and sliding means 10b engaging slidably with said guiding means 10a, and fastened, preferably at intervals, to said panel 9.

The fastening means 10 are at the same time also spacing means between the panel 9 and the upright 4. Therefore the panels 9 of the protective structure according to the invention are not in direct contact with the upright, but the fastening means are fitted so as to create a small gap between the panel 9 and the upright 4.

As shown in FIG. 2, for the purpose of creating a gasket barrier capable of insulating the internal environment and limiting the noise emission of the apparatus to the external environment, a tubular gasket wall 11 is fitted, according to the invention, between the frame of the protective structure and the panels 9. This is closed at both ends so as to form the boundaries of a closed internal cavity and is held in position by fastening its ends respectively to the uprights 4 or to the perimeter edge 6 at the top and to the reinforcing bars 7 at the bottom of the protective structure 1.

The tubular gasket wall 10 is of elastic material. In particular, the wall is formed from an elastomer resistant to sterilising products such as oxygenated water, steam, detergent foams with bactericides, chlorine and other commonly used detergents. Preferably the wall is formed from polyurethane elastomers compatible with food processing applications.

The gasket wall 11 is positioned in the above-mentioned gap created between the panel 9 and upright 4 by the spacer fastening means 10, so as to extend along the entire length of the joint edge of the panel 9 and of the upright 4. However, as shown schematically in FIG. 4a, this wall 11, in the non-operating condition, does not adhere to or make any contact with the panel 9 or the upright 4 of the frame 2.

The tubular gasket wall 11 is connected by its internal cavity to means of supplying fluids under pressure (the supply system is not shown in the drawing) which may be positioned inside the equipment or in a remote position. These means will for example be compressors for supplying compressed air.

The gasket walls 11 are connected to said supply means by means of tubes (not shown in the drawing) which, running from the supply means, are inserted in small holes arranged on the surface of the gasket walls, preferably at one end of said walls 11. The gasket walls 11 of the protective structure 1 are fitted singly along the respective joint surfaces, one for each side edge and if necessary one for each upper and lower edge of each panel.

The gasket walls 11 may be connected in series or in parallel to the means of supplying fluids under pressure. When the connection is in parallel, there are as many feed tubes running from the means of supplying fluids under pressure as there are gasket walls 11 to be supplied and therefore each individual tubular wall 11 is supplied individually by means of a single tube which is preferably inserted at one end. If instead the connection is in series, a single supply tube runs from the supply unit and is connected to the first tubular gasket wall of the series. In turn, a second tube, the outlet, runs from this and is preferably inserted at the opposite end relative to the inlet tube, which connects the first gasket wall to a second gasket wall. In turn, this second gasket wall is connected to said input tube and to a second output tube which connects it to the next gasket wall. In this way all the gasket walls 11 of the protective structure are connected one after the other.

When the apparatus is in operation, the gasket wall 11 is supplied on the inside, by means of said supply means, with a fluid under pressure. In this way, because of the pressure exerted from the inside of the wall 11 by the fluid, the elastic wall tends to expand, as shown schematically in FIG. 3b. Due to the effect of the expansion, the wall is thus made to adhere completely to the surface of the uprights of the protective structure and to the side surface of the panel 9 respectively. The expanded wall thus acts as a sealing gasket, providing both airtight and sound insulation of the internal part of the apparatus from the external environment. It is clear that the gasket wall 11 in its initial unexpanded form will have to be positioned relative to the frame 2 and to the panel 9 at a distance such that the degree of expansion of the wall caused by the inward flow of compressed fluid enables the wall to be in close contact with the surfaces of the adjacent protective structures.

When on the other hand the apparatus is not in operation, the input of fluids under pressure is suspended and therefore the gasket wall 11, being elastic, again assumes its initial tubular shape and size, becoming separated from the surface of the frame 2 and of the moveable panel 9 and therefore ceasing to have any contact with the protective structures.

In this non-operating and therefore non-expanded configuration, it is easy to clean the perimeter surface of the gasket wall 11, and also the joint surfaces between the upright 4 and panel 9 of the protective structure 1, since, as there is no contact between said surfaces, there is no area of adhesion to create gaps or closed areas which are difficult to reach.

In a particular form of embodiment of the invention, the tubular gasket wall 11 has an ovoid or elliptical shape in cross-section, as shown schematically in FIG. 4. The ovoid wall is arranged in the gap created by the fastening means 10 between the panel 9 and the upright 4, in such a way that the longer sides face the joint areas respectively of the panel 9 and of the upright 4. In fact the oval-shaped tubular wall of elastomer material advantageously possesses the characteristic of having the point of maximum expansion precisely at the longer sides of the oval cross-section. In this case, therefore, the point of maximum expansion of the gasket wall 11 subjected to the pressure exerted by the fluid under pressure in its internal cavity is made to coincide with that part of the wall which will be brought into contact with the surfaces of the protective structure, thus ensuring effective and close contact.

From what has been described above, the advantages of the gasket device according to the invention immediately appear.

Indeed, the gasket device for an apparatus for the handling of containers which is the subject of the invention effectively performs the primary function of a barrier to noise emission from the apparatus to the outside. The elastic gasket wall, expanding under the action of the internal pressure exerted by the fluid, is capable of adhering completely to the surface of the framework and of the panel, exactly following the contours of said surfaces, and in this way ensuring close contact between the gasket and the fixed and movable structures respectively.

The gasket device of the invention is therefore capable of ensuring optimum insulation over time and in any working condition, since it does not lose the capability of adhering completely to the joint surfaces of the framework structure and of the panel. At each working cycle, the capability of the gasket wall to adhere to the surfaces of the protective means and to ensure an effective barrier function is constant and depends only on the pressure exerted by the flow on the inside of the wall, said flow under pressure being adjustable by means of the supply means cited above.

At the same time a further fundamental advantage of the invention is that of having developed a gasket which offers maximum hygiene of the device itself. This is because the tubular wall in its non-expanded form does not adhere to the fixed surface of the support structure or to the panels. In this way, no gaps which are difficult to reach and in which dirt may accumulate are created. Also, the perimeter surface of the wall is free from any contact and therefore can be completely cleanable. Moreover, the material of the gasket wall is an elastomer resistant to sterilising products. These features allow optimum maintenance of the device and consequently the serviceability of the gasket is maintained over time.

Finally, a further advantage of the gasket described here is the fact of having provided a device which performs its noise barrier function only when the apparatus is in operation and therefore when sound insulation to the outside is actually required. When the equipment of the apparatus is not in operation, the wall returns to its initial non-expanded shape, ceases to be in contact as a seal with the protective structure and therefore ceases to act as barrier. This form of the wall separated from the panel and from the frame allows the panel to be opened repeatedly by the operator without weakening the elastic wall mechanically or due to wear, for example by rubbing or by flattening. This characteristic also advantageously ensures optimum retention over time of the elastic characteristics of the wall, limiting wear in the gasket wall.

Clearly, only one form of embodiment of the gasket device which is the subject of the invention has been described, and a person skilled in the art will be able to make all the changes required to adapt it to particular applications, without thereby departing from the protective scope of the invention.

For example, the shape and size of the elastic tubular wall will vary according to requirements, particularly depending on the joint area between the protective fixed structure and movable structure with which it is associated and at which the noise barrier function must be provided.

Moreover, it is clear that the gasket device described in the invention in the particular form of embodiment of application to a panel of a protective structure of an apparatus for the handling of containers, can be adapted to any other application in which it is necessary to create a noise barrier with seals between an internal environment and an external environment and in which this gasket device is fitted between two elements spaced apart from each other at their joint surfaces.

1. A protective structure (1) for an apparatus for the handling of containers comprising a frame (2), panels (9) for insulating it from the external environment, fastened to said frame (2) by fastening means (10) which create a gap between said frame (2) and said panels (9), and gasket means arranged in said gap, said gasket means comprising a tubular gasket wall (11) which can be expanded by forcing in fluids under pressure, characterised in that in non-operating conditions the gasket wall (11) become separated from the surface of the frame (2) and of the panel (9), therefore ceasing to have any contact with the protective structure; opposite ends of said gasket wall being fastened respectively to top and bottom portions of the frame (2), thereby holding in position said gasket wall.

2. A protective structure according to claim 1 in which said gasket wall (11) in operating conditions is expanded by a supply of said fluids under pressure until it engages to form a seal with the surfaces of said panels (9) and said frame (2).

3. A protective structure according to claim 1 in which said gasket wall (11) is tubular and closed at both ends.

4. A protective structure according to claim 3 in which said gasket wall (11) has an ovoid or elliptical shape in cross-section.

5. A protective structure according to claim 1 in which said gasket walls (11) are of elastic material.

6. A protective structure according to claim 5 in which said gasket wall (11) is formed from an elastomer resistant to sterilising products.

7. A protective structure according to claim 5 in which said gasket wall 11 is formed from polyurethane elastomers compatible with food processing applications.

8. A protective structure according to claim 1 in which said gasket wall (11) is in connection with means of supplying fluids under pressure.

9. A protective structure according to claim 8 in which said means of supplying fluids under pressure are compressors for the supply of compressed air.

10. A protective structure according to claim 8 in which the connection between said gasket wall (11) and said means of supplies of fluids under pressure is made by means of tubes which are inserted into small holes arranged on the surface of said gasket wall (11).

11. A protective structure according to claim 8 in which the connection between said gasket wall (11) and said means for supplies of fluids under pressure is in series or in parallel.

12. A protective structure according to claim 1 in which said panels (9) are fastened to said frame (2) in a fixed manner.

13. A protective structure according to claim 1 in which said panels (9) are fastened to said frame (2) in a movable manner.

14. A protective structure according to claim 13 in which said fastening means (10) comprise hinging means and locking means.

15. A protective structure according to claim 13 in which said fastening means (10) comprise guidance means (10a) and sliding means (10b) which engage slidably in said guidance means (10a).

16. The protective structure according to claim 1, wherein said frame comprises a plurality of uprights (4) connected at the upper end by a perimeter edge (6) and by reinforcing bars (7, 8), the ends of the gasket wall being fastened, respectively, to one of the uprights or to the perimeter edge at the top, and to one of the reinforcing bars at the bottom of the protective structure.
